(19) United States
(12) Patent Application Publication
(10) Pub. No.: US 2024/0198576 A1
(43) Pub. Date: Jun. 20, 2024

(54) POTASSIUM STEARATE OR BETA NUCLEATOR FOR MODIFICATION OF HETEROPHASIC POLYPROPYLENE BLOWN FILMS OR SHEETS

(71) Applicant: FINA TECHNOLOGY, INC., Houston, TX (US)

(72) Inventors: Michael McLeod, Houston, TX (US); Theodore Harris, Houston, TX (US); LuAnn Kelly, Friendswood, TX (US)

(21) Appl. No.: 18/533,889

(22) Filed: Dec. 8, 2023

Related U.S. Application Data
(60) Provisional application No. 63/432,853, filed on Dec. 15, 2022.

(51) Int. Cl. B29C 48/21; B29C 48/00; B29K 23/00

(52) U.S. Cl. CPC B29C 48/21; B29C 48/0018; B29K 2023/14; B29K 2995/0081; B29K 2995/0089; B29K 2995/0097

(57) ABSTRACT

A blown polypropylene film or sheet is disclosed. The film or sheet can include at least 95 wt. % of a polypropylene, and at least one β-nucleating agent or crystallization inhibitor, where the polypropylene blown film or sheet has a thickness of 0.5 mils to 15 mils, and where the polypropylene blown film has an increased dart impact strength, as measure by ASTM D1709, when compared with a second polypropylene blown film or sheet that has the same components in the same wt. % amounts as the polypropylene blown film or sheet except that the second polypropylene blown film or sheet does not include the at least one β-nucleating agent or crystallization inhibitor.

### CROSS REFERENCE TO RELATED APPLICATIONS

This application claims the benefit of U.S. Provisional Application 63/432,853, filed Dec. 15, 2022, the contents of which are incorporated into the present application by reference.

### BACKGROUND OF THE INVENTION

### A. Field of the Invention

The invention generally concerns polypropylene compositions and blown films and sheets made from the polypropylene compositions.

### B. Description of Related Art

Polypropylene films may be produced by a number of different production processes, including the cast film process, the blown film process, and the BOPP (biaxially oriented polypropylene) process. In the blown film process, polypropylene is melt-extruded through an annular die and the molten bubble passes through an air ring. The air ring expands the bubble and aids in cooling the molten polypropylene.

During the cooling process, polypropylene molecules within a molten film crystallize to form the final blown film. The polypropylene molecular structure and film processing conditions can play a role in controlling the final crystalline structure in the produced film or sheet. The underlying crystalline structure can affect a variety of film properties, including appearance and strength.

### SUMMARY OF THE INVENTION

As the costs of chemical raw materials continues to increase worldwide, there has been a desire to increase the material efficiency of polypropylene-based packaging materials. One method for increasing the material efficiency of polypropylene blown films or sheets is to increase the strength of blown films or sheets. A discovery has been made in the context of the present invention that includes a method for increasing the strength of blown polypropylene films or sheets by including in the films or sheets particular compounds that can affect polypropylene crystal structure. In one aspect, it was discovered that including at least one β-nucleating agent or crystallization inhibitor in a polypropylene composition and producing a blown polypropylene film or sheet from the resulting composition imparts increased dart impact strength of the blown polypropylene film or sheet. This improvement can be verified by comparing the dart impact strength of the blown polypropylene film or sheet to the dart impact strength of a blown polypropylene film or sheet made of a comparable polypropylene composition lacking the β-nucleating agent and crystallization inhibitor. In some instances, polypropylene in the comparable polypropylene composition is increased in an amount to make up for the amount of β-nucleating agent and/or crystallization inhibitor not included in the comparable polypropylene composition. By including at least one β-nucleating agent or crystallization inhibitor in a polypropylene composition, the inventors have developed a high breaking point polypropylene composition that exhibits increased resistance to stresses and strains. This can be particularly advantageous in blown polypropylene film or sheet applications.

In one aspect of the present invention, there is disclosed a blown polypropylene film or sheet comprising at least 95 wt. % of a polypropylene and at least one β-nucleating agent or crystallization inhibitor, wherein the polypropylene blown film or sheet has a thickness of 0.5 mils to 15 mils and has an increased dart impact strength, as measure by ASTM D1709, when compared with a second polypropylene blown film or sheet that has the same components in the same amounts as the polypropylene blown film or sheet except that the second polypropylene blown film or sheet does not include at least one β-nucleating agent or crystallization inhibitor. In some instances, the amount of polypropylene in the second polypropylene blown film or sheet has increased in an amount to make up for the amount of β-nucleating agent and/or crystallization inhibitor not included in the second polypropylene blown film or sheet. In some instances, the amount of polypropylene in the second polypropylene blown film or sheet is the same amount used in the polypropylene blown film or sheet that includes the β-nucleating agent and/or crystallization inhibitor.

In one aspect, the polypropylene is an impact copolymer (ICP). In some aspects, the polypropylene is an impact copolymer propylene having at least one of or all of: a melt flow index of 0.1 to 5.0 g/10 min, preferably 0.5 to 1.5 g/10 min, more preferably 0.8 g/10 min, as measured by ASTM D1238 (230° C./2.16 kg); a melting point of 150 to 175° C., preferably 160 to 165° C., as measured by ASTM D3418; and a density of 0.7 to 1.1 g/cm³, preferably 0.8 to 1.0 g/cm³, more preferably 0.9 g/cm³, as measured by ASTM D1505.

In some aspects, the film or sheet comprises at least one β-nucleating agent. In some aspects, the β-nucleating agent is N′,N′-dicyclohexil-2,6-naphthalene dicarboxamide. In certain aspects, the film or sheet comprises at least one crystallization inhibitor. In particular aspects, the crystallization inhibitor is potassium stearate. In some aspects, the film or sheet comprises 0.02 wt. % to 0.5 wt. % of the β-nucleating agent and/or 0.02 wt. % to 0.5 wt. % of the crystallization inhibitor.

In some aspects, the film or sheet is a multi-layered film or sheet. In further aspects, the multi-layered film or sheet is an A/B/A co-extruded blown film or sheet, wherein A is a first layer and a third layer and B is a second layer positioned in between the first and third layers, and wherein the first and third layers have the same composition. In a particular aspect, the A/B/A film or sheet has a 15/70/15% structure. In certain aspects, each of the first, second, and third layers each comprise at least 95 wt. % of a polypropylene. In particular aspects, the first and third layers comprise at least one β-nucleating agent and/or the at least one crystallization inhibitor. In certain aspects, the second layer comprises at least one β-nucleating agent and/or the at least one crystallization inhibitor. In one aspect, the second layer comprises the at least one β-nucleating agent or crystallization inhibitor, and the first and third layers do not comprise either of the least one β-nucleating agent or the at least one crystallization inhibitor.

In some aspects, a polypropylene blown film or sheet as disclosed herein has at least one of or all of the following properties: a dart impact strength of 75 g/mil to 250 g/mil or any range or number therein (e.g., 75, 80, 85, 90, 95, 100, 110, 120, 130, 140, 150, 160, 170, 180, 190, 200, 210, 220, 230, 240, or 250 g/mil), as measured by ASTM D1709; a maximum load in slow puncture test of 2 lbf/mil to 4 lbf/mil or any range or number therein (e.g., 2, 3, or 4 lbf/mil), as measured by ASTM F1306; a total energy in slow puncture test of 0.75 in-lbs/mil to 2 in-lb/mil or any range or number therein (e.g., 0.75, 0.80, 0.85, 0.90, 0.95, 0.10, 0.20, 0.30, 0.40, 0.50, 0.60, 0.70, 0.80, 0.90, 1.00, 1.10, 1.20, 1.30, 1.40, 1.50, 1.60, 1.70, 1.80, 1.90, or 2.00 in-lbs/mil), as measured by ASTM F1306; an elongation at break in slow puncture test of 0.5 inches to 1.25 inches or any range or number therein (0.5, 0.6, 0.7, 0.8, 0.9, 1.0, 1.1, 1.2, or 1.25 inches), as measured by ASTM F1306; and/or a transverse direction tear strength of 50 g/mil to 250 g/mil or any range or number therein (e.g., 50, 55, 60, 65, 70, 75, 80, 85, 90, 95, 100, 110, 120, 130, 140, 150, 160, 170, 180, 190, 200, 210, 220, 230, 240, or 250 g/mil), as measured by ASTM D1922.

In some aspects, the polypropylene in a polypropylene blown film or sheet as disclosed herein is a polypropylene homopolymer, random copolymer, or a blend thereof. In another aspect, the polypropylene is a Ziegler-Natta catalyzed polypropylene or a metallocene-catalyzed polypropylene. In a particular aspect, the crystallization inhibitor is a stearate salt. In certain aspects, the stearate salt comprises a cation selected from sodium, potassium, magnesium, or calcium, preferably potassium. In some aspects, the β nucleating agent is N′,N′-dicyclohexil-2,6-naphthalene dicarboxamide, a gamma quinacridone, an aluminum salt of quinizarin sulphonic acid, a dihydroquinoacridin-dione, a quinacridin-tetrone, a triphenenol ditriazine, a combination of calcium carbonate and an organic acid, a combination of calcium stearate and pimelic acid, a calcium silicate, a dicarboxylic acid salt of metals of Group IIA, a delta-quinacridone, a diamide of adipic or suberic acid, a calcium salts of suberic or pimelic acid, an indigosol or cibantine organic pigment, an anthraquinone red pigment, or a bis-azo yellow pigment, or any combination thereof, preferably N′,N′-dicyclohexil-2,6-naphthalene dicarboxamide.

In some aspects, the blown polypropylene film or sheet can have a thickness of 0.1 mils to 30 mils, preferably 0.5 mils to 15 mils, or any number or range therein (e.g., 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mils). A mil is one thousandth of an inch. 1 mil=0.0254 millimeters. Films typically have a thickness of 10 mils or less. Sheets typically have a thickness of greater than 10 mils.

Also disclosed in the context of the present invention is an article of manufacture that includes the polypropylene blown film or sheet of the present invention. Non-limiting examples of articles of manufacture are provided throughout this specification.

Also disclosed is a process for producing a polypropylene blown film or sheet. The process can include obtaining an extrusion composition comprising at least one polypropylene resin and at least one of a crystallization inhibitor or a β nucleating agent, extruding the extrusion composition through a first annular die to form a first molten tube, blowing the first molten tube into a first tubular blown film or sheet, and collapsing the first tubular blown film or sheet to form the polypropylene blown film or sheet. In certain aspects, a ratio of the diameter of the first molten tube to a diameter of the first annular die ranges from 1 to 5. In some aspects, the process further comprises providing an air stream at a temperature ranging from 5 to 20° C. to the first tubular blown film or sheet interior to quench the first molten tube.

Also disclosed is a process for producing a multi-layer polypropylene blown film or sheet. In some aspects, the process can include the steps of: obtaining an extrusion composition comprising at least one polypropylene resin and at least one of a crystallization inhibitor or a β nucleating agent, extruding the extrusion composition through a first annular die to form a first molten tube, blowing the first molten tube into a first tubular blown film or sheet, and collapsing the first tubular blown film or sheet to form the polypropylene blown film or sheet, extruding the extrusion composition through a second annular die to form a second molten tube positioned concentrically within the first molten tube, blowing the second molten tube into a second tubular blown film or sheet positioned concentrically within the first tubular blown film or sheet, and collapsing the first and second tubular blown films or sheets to form a multi-layer blown film or sheet.

Also disclosed are aspects 1 to 27. Aspect 1 is a blown polypropylene film or sheet comprising: (a) at least 95 wt. % of a polypropylene; and (b) at least one β-nucleating agent or crystallization inhibitor, wherein the polypropylene blown film or sheet has a thickness of 0.5 mils to 15 mils, and wherein the polypropylene blown film or sheet has an increased dart impact strength, as measure by ASTM D1709, when compared with a second polypropylene blown film that has the same components in the same wt. % amounts as the polypropylene blown film except that the second polypropylene blown film does not include the at least one β-nucleating agent or crystallization inhibitor. Aspect 2 is the polypropylene blown film or sheet of aspect 1, wherein the polypropylene is an impact copolymer. Aspect 3 is the polypropylene blown film or sheet of any one of aspects 1 to 2, wherein the polypropylene is an impact copolymer propylene having at least one of or all of: a melt flow index of 0.1 to 5.0 g/10 min, preferably 0.5 to 1.5 g/10 min, as measured by ASTM D1238 (230° C./2.16 kg); a melting point of 150 to 175° C., preferably 160 to 165° C., as measured by ASTM D3418; and a density of 0.7 to 1.1 g/cm³, preferably 0.8 to 1.0 g/cm³, as measured by ASTM D1505. Aspect 4 is the polypropylene blown film or sheet of aspect 1, wherein the film or sheet comprises the at least one β-nucleating agent. Aspect 5 is the polypropylene blown film or sheet of aspect 4, wherein the β-nucleating agent is N′,N′-dicyclohexil-2,6-naphthalene dicarboxamide. Aspect 6 is the polypropylene blown film or sheet of aspect 1, wherein the film or sheet comprises the at least one crystallization inhibitor. Aspect 7 is the polypropylene blown film or sheet of aspect 6, wherein the crystallization inhibitor is potassium stearate. Aspect 8 is the polypropylene blown film or sheet of aspect 1, wherein the film or sheet comprises 0.02 wt. % to 0.5 wt. % of the β-nucleating agent and/or 0.02 wt. % to 0.5 wt. % of the crystallization inhibitor. Aspect 9 is the polypropylene blown film or sheet of aspect 1, wherein the film or sheet is a multi-layered film. Aspect 10 is the polypropylene blown film or sheet of aspect 9, wherein the multi-layered film or sheet is an A/B/A co-extruded blown film or sheet, wherein A is a first film or sheet layer and a third film or sheet layer and B is a second film or sheet layer positioned in between the first and third film or sheet layers, and wherein the first and third film or sheet layers have the same composition. Aspect 11 is the polypropylene blown film or sheet of aspect 10, wherein each of the first, second, and third layers each comprise at least 95 wt. % of a polypropylene. Aspect 12 is the polypropylene blown film or sheet of aspect 11, wherein the first and third layers comprise the at least one β-nucleating agent and/or the at least one crystallization inhibitor. Aspect 13 is the polypropylene blown film or sheet of aspect 11, wherein the second layer comprises the at least one β-nucleating agent and/or the at least one crystallization inhibitor. Aspect 14 is the polypropylene blown film or sheet of aspect 11, wherein the second film or sheet layer comprises the at least one β-nucleating agent or crystallization inhibitor, and wherein the first and third film or sheet layers do not comprise either of the least one β-nucleating agent or the at least one crystallization inhibitor. Aspect 15 is the polypropylene blown film or sheet of aspect 11, wherein the A/B/A film has a 15/70/15% structure. Aspect 16 is the polypropylene blown film or sheet of aspect 1, comprising at least one of or all of the following properties: a dart impact strength of 75 g/mil to 250 g/mil, as measured by ASTM D1709; a maximum load in slow puncture test of 2 lbf/mil to 4 lbf/mil, as measured by ASTM F1306; a total energy in slow puncture test of 0.75 in-lbs/mil to 2 in-lb/mil, as measured by ASTM F1306; an elongation at break in slow puncture test of 0.5 inches to 1.25 inches, as measured by ASTM F1306; and/or a transverse direction tear strength of 50 g/mil to 250 g/mil, as measured by ASTM D1922. Aspect 17 is the polypropylene blown film or sheet of aspect 1, wherein the polypropylene is a homopolymer or a random copolymer or a blend thereof. Aspect 18 is the polypropylene blown film or sheet of aspect 1, wherein the polypropylene is a Ziegler-Natta catalyzed polypropylene or a metallocene-catalyzed polypropylene. Aspect 19 is the polypropylene blown film or sheet of aspect 1, wherein the crystallization inhibitor is a stearate salt. Aspect 20 is the polypropylene blown film or sheet of aspect 19, wherein the stearate salt comprises a cation selected from sodium, potassium, magnesium, or calcium, preferably potassium. Aspect 21 is the polypropylene blown film or sheet of aspect 1, wherein the β nucleating agent is N′,N′-dicyclohexil-2,6-naphthalene dicarboxamide, a gamma quinacridone, an aluminum salt of quinizarin sulphonic acid, a dihydroquinoacridin-dione, a quinacridin-tetrone, a triphenenol ditriazine, a combination of calcium carbonate and an organic acid, a combination of calcium stearate and pimelic acid, a calcium silicate, a dicarboxylic acid salt of metals of Group IIA, a delta-quinacridone, a diamide of adipic or suberic acid, a calcium salts of suberic or pimelic acid, an indigosol or cibantine organic pigment, an anthraquinone red pigment, or a bis-azo yellow pigment, or any combination thereof, preferably N′,N′-dicyclohexil-2,6-naphthalene dicarboxamide. Aspect 22 is the polypropylene blown film or sheet of aspect 1, wherein the film or sheet further comprises an additive, wherein the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof. Aspect 23 is an article of manufacture comprising the polypropylene blown film or sheet of aspect 1. Aspect 24 is a process for producing a polypropylene blown film or sheet of aspect 1, the process comprising: obtaining an extrusion composition comprising at least one polypropylene resin and at least one of a crystallization inhibitor or a β nucleating agent; extruding the extrusion composition through a first annular die to form a first molten tube; blowing the first molten tube into a first tubular blown film or sheet; and collapsing the first tubular blown film or sheet to form the polypropylene blown film or sheet. Aspect 25 is the process of aspect 24, wherein a ratio of the diameter of the first molten tube to a diameter of the first annular die ranges from 1 to 5. Aspect 26 is the process of aspect 24, further comprising providing an air stream at a temperature ranging from 5 to 20° C. to the first tubular blown film interior to quench the first molten tube. Aspect 27 is the process of aspect 24, further comprising: extruding the extrusion composition through a second annular die to form a second molten tube positioned concentrically within the first molten tube; blowing the second molten tube into a second tubular blown film or sheet positioned concentrically within the first tubular blown film or sheet; and collapsing the first and second tubular blown films or sheets to form a multi-layer blown film or sheet.

Other aspects or embodiments of the invention are discussed throughout this application. Any aspect or embodiment discussed with respect to one aspect of the invention applies to other aspects or embodiments of the invention as well and vice versa. Each aspect or embodiment described herein is understood to be aspects or embodiments of the invention that are applicable to other aspects of the invention. It is contemplated that any aspect or embodiment discussed herein can be combined with other aspects or embodiments discussed herein and/or implemented with respect to any method or composition of the invention, and vice versa. Furthermore, compositions and systems of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, X, Y, and/or Z can include: X alone, Y alone, Z alone, a combination of X and Y, a combination of X and Z, a combination of Y and Z, or a combination of X, Y, and Z.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present invention can “comprise,” “consist essentially of,” or “consist of” particular ingredients, components, compositions, steps, etc., disclosed throughout the specification. With respect to the transitional phrase “consisting essentially of,” in one non-limiting aspect, a basic and novel characteristic of the compositions and processes of the present invention include the use of a β-nucleating agent and/or crystallization inhibitor in a polypropylene composition for increasing the dart impact strength of a blown film or sheet made from the polypropylene composition.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a graphical representation of the dart impact strength (grams) of compositionally monolithic films.

FIGS. 2A-2B Elmendorf tear strength of compositionally monolithic films. FIG. 2A is a graphical representation of Elmendorf tear strength (grams) of compositionally monolithic films, measured in the Machine direction (MD). FIG. 2B is a graphical representation of Elmendorf tear strength (grams) of compositionally monolithic films, measured in the Transverse direction (TD).

FIG. 3 is a graphical representation of puncture resistance testing total energy (in-lbs) of compositionally monolithic films.

FIG. 4 is a graphical representation of the dart impact strength (grams) of films having different core compositions (and no additive in skin layers).

FIGS. 5A-5B Elmendorf tear strength of films having different core compositions (and no additive in skin layers). FIG. 5A is a graphical representation of Elmendorf tear strength (grams) of films having different core compositions, measured in the Machine direction (MD).

FIG. 5B is a graphical representation of Elmendorf tear strength (grams) of films having different core compositions, measured in the Transverse direction (TD).

FIG. 6 is a graphical representation of puncture resistance testing total energy (in-lbs) of films having different core compositions (and no additive in skin layers).

FIG. 7 is a graphical representation of puncture testing elongation at break (lbf) of films having different core compositions (and no additive in skin layers).

FIG. 8 is a graphical representation depicting the influence of nucleator inhibitor placement in different layers on falling dart performance.

FIGS. 9A-9B Elmendorf tear performance of films having nucleator inhibitor in different layers. FIG. 9A is a graphical representation depicting the influence of nucleator inhibitor placement in different layers on MD tear resistance. FIG. 9B is a graphical representation depicting the influence of nucleator inhibitor placement in different layers on MD tear resistance.

FIGS. 10A-10B Puncture test results of films having nucleator inhibitor in different layers. FIG. 10A is a graphical representation depicting the influence of nucleator inhibitor placement in different layers on total puncture energy (in-lbs). FIG. 10B is a graphical representation depicting the influence of nucleator inhibitor placement in different layers on maximum puncture load (lbf).

FIG. 11 is a graphical representation comparing the dart impact strength (grams) of compositionally monolithic films and films having a nucleator modifier (beta nucleator and/or nucleation inhibitor) in the core. The dotted line represents the dart impact strength (243 grams) of baseline film 1 (no nucleator modifier in any layers).

FIG. 12 is a graphical representation comparing MD tear resistance (grams) of compositionally monolithic films and films having a nucleator modifier (beta nucleator and/or nucleation inhibitor) in the core. The dotted line represents the MD tear strength (36.4 grams) of baseline film 1 (no nucleator modifier in any layers).

FIG. 13 is a graphical representation comparing TD tear resistance (grams) of compositionally monolithic films and films having a nucleator modifier (beta nucleator and/or nucleation inhibitor) in the core. The dotted line represents the TD tear strength (289.7 grams) of baseline film 1 (no nucleator modifier in any layers).

FIGS. 14A-14B Total puncture strength and maximum puncture load. FIG. 14A is a graphical representation comparing total puncture strength of compositionally monolithic films and films having a nucleator modifier (beta nucleator and/or nucleation inhibitor) in the core. The dotted line represents the total puncture strength (2.55 in-lbs) of baseline film 1 (no nucleator modifier in any layers). FIG. 14B is a graphical representation comparing maximum puncture load of compositionally monolithic films and films having a nucleator modifier (beta nucleator and/or nucleation inhibitor) in the core. The dotted line represents the maximum puncture load (5.31 lbf) of baseline film 1 (no nucleator modifier in any layers).

### DETAILED DESCRIPTION OF THE INVENTION

One aspect of the present invention is based on a discovery that polypropylene blown film kinematics and resulting film physical properties can be modified by the addition of a beta nucleator and/or a nucleation inhibitor. By including one or both of these additives in polypropylene compositions, the inventors have discovered a method for altering blown film crystalline structure in such a way that imparts the film with increased resistance to stresses and strains. The improved stress and strain resistance can be directly measured by various film strength analyses, including assessment of dart strength, which demonstrates that the films exhibit increased resistance to breaking and piercing.

These and other non-limiting aspects of the present invention are discussed in further detail in the following sections.

### A. Polypropylene

All types of polypropylene polymers are contemplated as being useful in the context of the present invention. In one particular aspect, the polypropylene can be an impact copolymer (ICP). ICPs are typically characterized as thermoplastic polymers produced through the polymerization of propylene and ethylene by using Ziegler Natta catalysts. ICPs can have a heterophasic amorphous structure inside a semi-crystalline polypropylene homopolymer matrix. The copolymer can include at least two phases, a semicrystalline polypropylene homopolymer matrix, and a rubbery ethylene-propylene copolymer phase or a mixture of rubbery ethylene-propylene copolymers dispersed within the polypropylene matrix. The crystalline matrix phase can provide the strength and stiffness. The rubbery phase can impart impact resistance. In some aspects, the ICP can have at least one of or all of the following properties: a melt flow index of 0.1 to 5.0 g/10 min, preferably 0.5 to 1.5 g/10 min, more preferably 0.8 g/10 min, as measured by ASTM D1238 (230° C./2.16 kg); a melting point of 150 to 175° C., preferably 160 to 165° C., as measured by ASTM D3418; and a density of 0.7 to 1.1 g/cm³, preferably 0.8 to 1.0 g/cm³, more preferably 0.9 g/cm³, as measured by ASTM D1505. A commercially available ICP that can be used in the context of the present invention includes Polypropylene 4170 (TotalEnergies, Houston, Texas, USA).

In other aspects of the present invention, the polypropylene used in the polypropylene blown films or sheets can include a polypropylene homopolymer, random copolymer, or a blend thereof. In another aspect, the polypropylene is a Ziegler-Natta catalyzed polypropylene or a metallocene-catalyzed polypropylene. The polypropylene homopolymers can be isotactic, syndiotactic, atactic polypropylene. In some aspects, a controlled rheology grade polypropylene (CRPP) can be used. A CRPP is one that has been further processed (e.g., through a degradation process) to produce a polypropylene polymer with a targeted high melt flow index (MFI), lower molecular weight, and/or a narrower molecular weight distribution than the starting polypropylene.

Polypropylene can be prepared by any of the polymerization processes, which are in commercial use (e.g., a “high pressure” process, a slurry process, a solution process and/or a gas phase process) and with the use of any of the known catalysts (e.g., Ziegler Natta catalysts, chromium or Phillips catalysts, single site catalysts, metallocene catalysts, and the like). Polypropylene can be prepared using methods described in U.S. Pat. Nos. 8,957,159, 8,088,867, 8,071,687, 7,056,991 and 6,653,254. The polypropylene can also be purchased through a commercial source such as those from TotalEnergies (USA), LyondellBasel Industries, Reliance Industries Ltd, Sinopec, and ExxonMobil Chemical Co. The polypropylene can be in previously extruded and/or be in solid form, for example, pellets.

### B. Crystallization Inhibitors and β-Nucleating Agents

Crystallization inhibitors and/or β-nucleating agents can be used in the polypropylene compositions of the present invention. Non-limiting examples of crystallization inhibitors include stearate salts. Examples of stearate salts include sodium stearate, potassium stearate, magnesium stearate, or calcium stearate, or combinations thereof. In some preferred aspects, potassium stearate can be used. Stearate salts are commercially available from a wide-range of companies, an example of which is Sigma-Aldrich (St. Louis, Missouri, USA). The polypropylene compositions of the present invention can include 0.001 wt. % to 2 wt. %, preferable 0.01 wt. % to 1 wt. %, or more preferably, 0.02 wt. % to 0.5 wt. % of a crystallization inhibitor, or any amount or range therein (e.g., 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, or 2 wt. %).

Non-limiting examples of β-nucleating agents that can be used in the polypropylene compositions of the present invention include N′,N′-dicyclohexil-2,6-naphthalene dicarboxamide, a gamma quinacridone, an aluminum salt of quinizarin sulphonic acid, a dihydroquinoacridin-dione, a quinacridin-tetrone, a triphenenol ditriazine, a combination of calcium carbonate and an organic acid, a combination of calcium stearate and pimelic acid, a calcium silicate, a dicarboxylic acid salt of metals of Group IIA, a delta-quinacridone, a diamide of adipic or suberic acid, a calcium salts of suberic or pimelic acid, an indigosol or cibantine organic pigment, an anthraquinone red pigment, or a bis-azo yellow pigment, or any combination thereof. In some preferred aspects, N′,N′-dicyclohexil-2,6-naphthalene dicarboxamide is used. β-nucleating agents are commercially available from a wide-range of companies, an example of which is New Japan Chemical Co., Ltd. (Osaka, Japan). By way of example, N′,N′-dicyclohexil-2,6-naphthalene dicarboxamide is available from New Japan Chemical Co., Ltd., as NJ Star® NU-100. The polypropylene compositions of the present invention can include 0.001 wt. % to 2 wt. %, preferable 0.01 wt. % to 1 wt. %, or more preferably, 0.02 wt. % to 0.5 wt. % of a β-nucleating agent, or any amount or range therein (e.g., 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, or 2 wt. %).

### C. Polypropylene Compositions

The polypropylene composition can contain at least 95 wt. % polypropylene, such as 95 wt. % to 100 wt. %, or equal to any one of, at least any one of, at most any one of, or between any two of 95, 96, 97, 98, 99, 99.1, 99.2, 99.3, 99.4, 99.5, 99.6, 99.7, 99.8 and 99.9, 99.95 and 100 wt. % of the polypropylene based on the total weight of the composition. In some aspects, the polypropylene can be a polypropylene homopolymer. In certain aspects, the polypropylene composition can have, any one of, any combination of, or all of: i) MFR of 0.5 g/10 min to 150 g/10 min, or equal to any one of, at least any one of, at most any one of, or between any two of 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, and 150 g/10 min, measured in accordance with ASTM D1238 (230° C./2.16 kg); ii) a specific gravity or density of 0.85 g/cc to 0.95 g/cc, or equal to any one of, at least any one of, at most any one of, or between any two of 0.85, 0.86, 0.87, 0.88, 0.89, 0.9, 0.91, 0.92, 0.93, 0.94 and 0.95 g/cc as measured in accordance with ASTM D1505; and/or iii) a melting point of 140° ° C. to 180° C., or equal to any one of, at least any one of, at most any one of, or between any two of 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, and 180° C. as measured using differential scanning calorimetry (DSC).

As indicated above, the polypropylene compositions of the present invention can also include a crystallization inhibitor and/or a β-nucleating agent. Each of the crystallization inhibitor and/or β-nucleating agent can be included in the polypropylene compositions of the present invention in amounts of 0.001 wt. % to 2 wt. %, preferable 0.01 wt. % to 1 wt. %, or more preferably, 0.02 wt. % to 0.5 wt. % of a β-nucleating agent, or any amount or range therein (e.g., 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, or 2 wt. %).

### D. Additional Additives

In addition to the crystallization inhibitors and β-nucleating agents, additional additives can be included in the polypropylene compositions of the present invention. Non-limiting examples of additional additives include an antiblocking agent, an antistatic agent, an antioxidant, a neutralizing agent, a blowing agent, a crystallization aid, a dye, a flame retardant, a filler, an impact modifier, a mold release agent, an oil, another polymer, a pigment, a processing agent, a reinforcing agent, a clarifying agent, a slip agent, a flow modifier, a stabilizer, an UV resistance agent, and combinations thereof. Additives are available from various commercial suppliers. Non-limiting examples of commercial additive suppliers include BASF (Germany), Dover Chemical Corporation (U.S.A.), Nouryon (The Netherlands), Sigma-Aldrich® (U.S.A.), Arkema Inc., and the like. The amount of optional additives can range from 0.01 wt. % to 5 wt. % (e.g., 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %, or any value or range there between) in the polypropylene composition.

### E. Blown Films or Sheets

The blown films or sheets disclosed herein may be part of a multilayer structure, i.e., one having at least two layers, such as for example a multilayer film or a laminate. In some aspects, the multilayer film or sheet comprises a core layer sandwiched between two skin layers. The blown film or sheet of the present invention can be produced by providing a polypropylene composition as disclosed herein to a first extruder. The polypropylene composition is melt-extruded through an annular die to form a first extrudate, which is in form of a bubble. The melt temperature in the melt-extrusion step can be in the range from 180º C. to 300° C., preferably in the range from 190° C. to 290° C., and more preferably in the range from 200° C. to 280° C. The first extrudate then passes through an air ring, which expands the bubble and aids in cooling the molten polypropylene. The first extrudate is then cooled by means of air and/or water on the outer and/or inner surfaces of said first extrudate. In some aspects, the first extrudate is cooled by means of air on the outer and/or inner surfaces of said first extrudate. Processes for blown film or sheet production are for example described in Polypropylene Handbook, ed. Nello Pasquini, 2nd edition, Carl Hanser Verlag, Munich 2005, pages 412-414.

In addition to the steps for the production of the blown film or sheet as disclosed herein, the process for the production of the multilayer films or sheets of the present invention can further comprise the steps of providing at least one further polymer composition to a corresponding number of further extruders. The at least one further polymer composition can be melt-extruded through an annular die to form at least one further extrudate. Then, this at least one further extrudate and the first extrudate, i.e., that of the polypropylene composition, can be combined to form a combined extrudate, which is in form of a bubble; and which is then cooled as described above.

### F. Articles of Manufacture

The blown polypropylene films or sheets of the present invention can be included in an article of manufacture. In some aspects, the article of manufacture can be transparent. Non-limiting examples of articles of manufacture can include, a packing filling, a forming film or sheet, a protective packaging, a shrink sleeve, and/or label, a shrink film or sheet, a twist wrap, a sealant film or sheet, film or sheet cushioning, film or sheet skins, heavy duty shipping sacks (HDSS), covers, autoclavable bag, roofing underlayment, mulch film, bag-inbox film, geoliner, membrane, etc. In these and other uses the polypropylene compositions may be combined with other materials, such as particulate materials, including talc, calcium carbonate, wood, and fibers, such as glass or graphite fibers, to form composite materials.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### A. Example 1—Preparation of Polypropylene Compositions

Four polypropylene compositions were produced using TotalEnergies 4170 base reactor polypropylene powder, a fractional melt flow rate impact copolymer with sufficient melt strength for use in blown films. The four compositions are depicted in Table 1 below:

TABLE 1
Polypropylene Compositions

| Composition | 1 | 2 | 3 | 4 |
|---|---|---|---|---|
| Irganox 1010 (wt. %) | 0.03 | 0.03 | 0.03 | 0.03 |
| Irgafos 168 (wt. %) | 0.05 | 0.05 | 0.05 | 0.05 |
| Calcium Stearate (wt. %) | 0.2 | 0.2 | 0 | 0 |
| Potassium Stearate (wt. %) | 0 | 0 | 0.2 | 0.2 |
| NJ Star NU-100 Beta Nucleator (wt. %) | 0 | 0.1 | 0 | 0.1 |

The four compositions were subsequently used to make eight coextruded film structures. The films were produced with a 15/70/15% skin/core/skin structure, also commonly called an A/B/A structure. The blow-up ratio was 2.5:1. Films were 2 mils thick. The film structures are depicted below in Table 2.

TABLE 2
Films - Layer Arrangement

| Film Number | 1 | 2 | 3 | 4 |
|---|---|---|---|---|
| Layer A | Composition 1 | Composition 1 | Composition 3 | Composition 3 |
| Layer B | Composition 1 | Composition 3 | Composition 1 | Composition 3 |
| Gloss | 11.3 | 11.3 | 11.4 | 11.3 |
| Note | Baseline | Layer B with | Layer A with | Layers A and B |
| | | inhibitor | inhibitor | with inhibitor |
| Film Number | 5 | 6 | 7 | 8 |
| Layer A | Composition 2 | Composition 4 | Composition 1 | Composition 1 |
| Layer B | Composition 2 | Composition 4 | Composition 2 | Composition 3 |
| Gloss | 9.8 | 9.8 | 11.2 | 11.1 |
| Note | Layers A and B | Layers A and B | Layer B with β- | Layers A and B |
| | with β-nucleator | with inhibitor and | nucleator | with inhibitor and |
| | | β-nucleator | | β-nucleator |

### B. Example 2—Comparison of Compositionally Monolithic Films

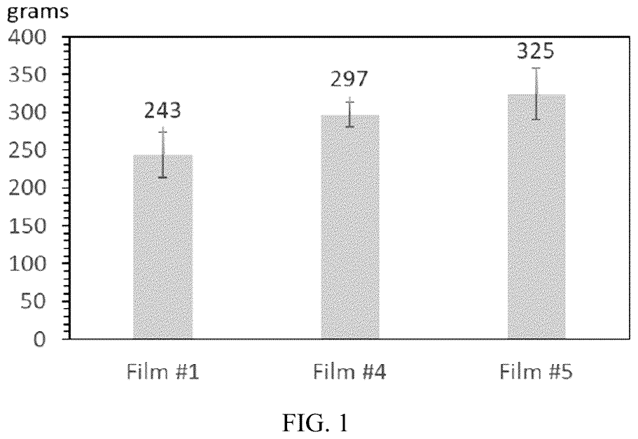

Properties of compositionally monolithic films 1, 4 and 5 were examined in order to discern the effects of a single additive in all layers without the potentially confounding impact of additives in fewer than all layers. Film 1 is a conventional unnucleated formulation, Film 4 includes a nucleation inhibitor, and Film 5 includes a beta nucleator. Between the three compositions, dart performance was improved in both cases versus the Film 1 baseline (FIG. 1). Inclusion of the beta nucleator (Film 5) generated a 34% increase in dart impact strength. Inclusion of nucleator inhibitor (Film 4) generated a 22% increase in dart impact strength. Both results are outside the bounds of the testing error, and are therefore statistically significant improvements.

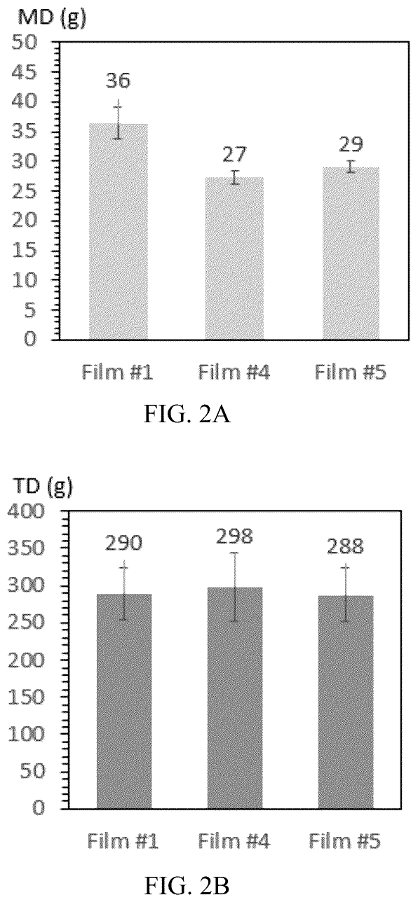

The compositionally monolithic films 1, 4 and 5 were examined for tear strength. Films 4 and 5 had lower machine direction (MD) tear strength (FIG. 2A) and comparable transverse direction (TD) strength (FIG. 2B). Both of these additive-inclusive films exhibited slightly different tear strengths as compared to no-additive Film 1, indicating that both the beta nucleator and nucleation inhibitor influence film properties.

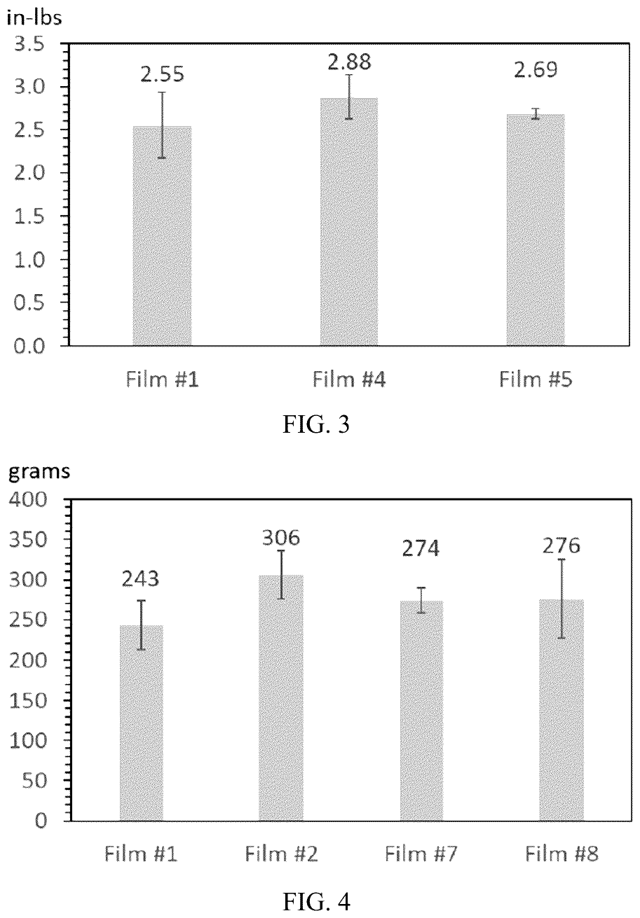

The compositionally monolithic films 1, 4 and 5 were examined for puncture resistance. Films 4 and 5 exhibited slightly higher total energy before puncturing (FIG. 3) and longer elongation at break (data not shown). Table 3 below includes monolithic film falling dart and Elmendorf tear data. Table 4 below includes monolithic film puncture test data.

TABLE 3
Monolithic Film Falling Dart and Tear Data

| Film | 1 | 4 | 5 |
|---|---|---|---|
| Note | Baseline | 100% inhibitor | 100% beta nucleator |
| Falling dart (g) | 243 | 297 | 325 |
| Falling dart Std. Dev. | 30 | 17 | 34 |
| Elmendorf Tear | | | |
| Pendulum Weight | 200 | 200 | 200 |
| MD | | | |
| Tear Resistance MD | 36.4 | 27.4 | 29 |
| (g) | | | |
| Pendulum Weight TD | 800 | 800 | 800 |
| Tear Resistance TD | 289.7 | 298.4 | 287.8 |
| (g) | | | |
| Tear Ratio TD/MD | 8 | 10.9 | 9.9 |
| Std. Dev. MD | 2.62 | 1.14 | 1 |
| Std. Dev. TD | 34.72 | 46.96 | 35.68 |

TABLE 4
Monolithic Film Puncture Data

| Film | 1 | 4 | 5 |
|---|---|---|---|
| Note | Baseline | 100% inhibitor | 100% beta nucleator |
| Maximum load (lbf) | 5.31 | 5.36 | 5.18 |
| Maximum load Std. | 0.13 | 0.28 | 0.04 |
| Dev. | | | |
| Total energy (in-lbs) | 2.554 | 2.881 | 2.688 |
| Total energy Std. | 0.38 | 0.26 | 0.06 |
| Dev. | | | |
| Force at break (lbf) | 5.1 | 5.05 | 4.91 |
| Force at break Std. | 0.07 | 0.24 | 0.04 |
| Dev. | | | |
| Elongation at break | 0.76 | 0.82 | 0.8 |
| (lbf) | | | |
| Elongation at break | 0.07 | 0.03 | 0.01 |
| Std. Dev. | | | |
| Gauge | 1.97 | 2 | 2 |
| Failure type | ⅔ no break, | no break | no break |
| | ⅓ break | | |

### C. Example 3—Effects of Changing Core Composition

The effects of changing film core compositions were examined. The films in this set of experiments included the same baseline, no-additive skin composition. Films 1, 2, 7 and 8 have a baseline core, a core with a nucleation inhibitor, a core with a beta nucleator, and a core with both a beta nucleator and nucleation inhibitor, respectively. Skin layers isolate and insulate heat transfer from the core, and it is possible that any beneficial results observed results from additives in the core layer. This type of experiment can also be useful in revealing unexpected synergies.

Falling dart performance was evaluated first (FIG. 4). All additive combinations performed better than the baseline. The greatest improvement in falling dart impact strength was observed by Film 7 (core with beta nucleator). No advantage was observed by Film 8 (core with both beta nucleator and nucleation inhibitor), and the performance matched that of Film 7 (core with beta nucleator). These results suggest that beta nucleation was the dominant factor in that film's performance.

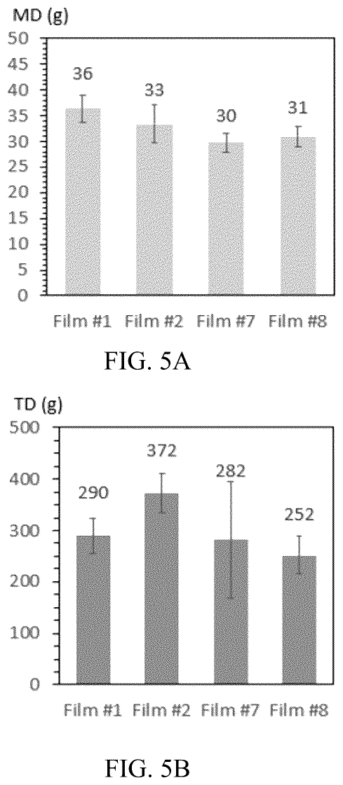

Films 1, 2, 7 and 8 were evaluated for Elmendorf tear strength. Tear strength was influenced by the use of the beta nucleator and nucleation inhibitor. Baseline Film 1 had the highest MD tear strength, with Film 2 (core with nucleation inhibitor) having the second highest MD tear strength (FIG. 5A). Film 2 had the highest TD tear strength, exceeding that of the baseline Film 1 by 28% (FIG. 5B). The effects with Films 7 (core with beta nucleator) and 8 (core with both beta nucleator and nucleation inhibitor) were more modest. These films exhibited a slight decline in MD strength relative to Film 1 and were less strong in the TD direction as well.

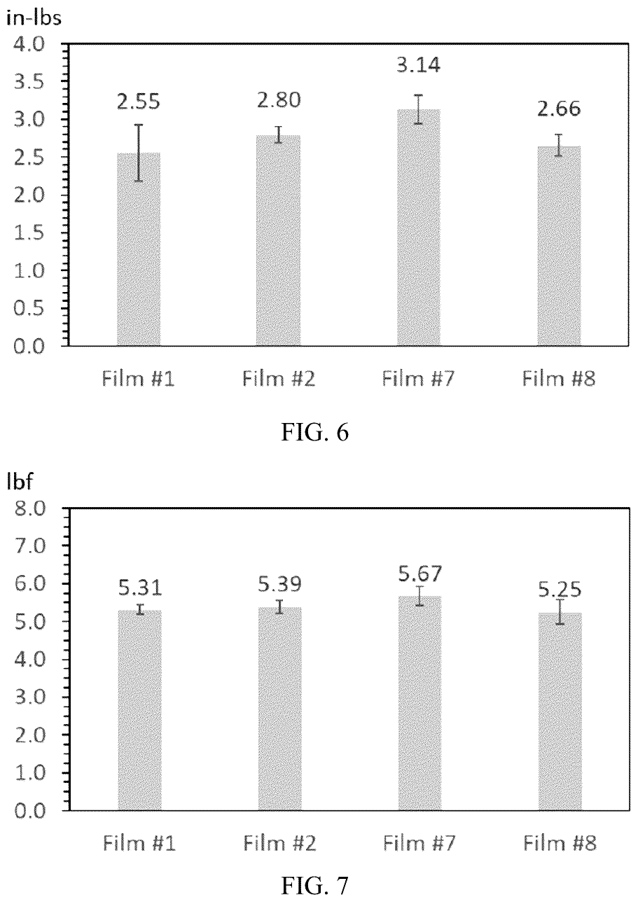

The films were subjected for their slow rate penetration resistance. Slow puncture results revealed a benefit conferred by the beta nucleator additive. Film 7 (core with beta nucleator) had improved maximum load performance (FIG. 6) and improved force at break (FIG. 7). This benefit was not realized in Film 2 (core with nucleation inhibitor) or Film 8 (core with both beta nucleator and nucleation inhibitor). Table 5 below includes film falling dart and Elmendorf tear data. Table 6 below includes film puncture test data.

TABLE 5
Falling Dart and Tear Data of Films
with Different Core Compositions

| Film | 1 | 2 | 7 | 8 |
|---|---|---|---|---|
| Note | Baseline | Core with | Core with beta | Core with beta |
| | | nucleation | nucleator | nucleator and |
| | | inhibitor | | nucleation |
| | | | | inhibitor |
| Falling dart (g) | 243 | 306 | 274 | 276 |
| Falling dart | 30 | 30 | 16 | 49 |
| Std. Dev. | | | | |
| Elmendorf Tear | | | | |
| Pendulum | 200 | 200 | 200 | 200 |
| Weight | | | | |
| MD | | | | |
| Tear Resistance | 36.4 | 33.4 | 29.8 | 31 |
| MD (g) | | | | |
| Pendulum | 800 | 800 | 800 | 800 |
| Weight | | | | |
| TD | | | | |
| Tear Resistance | 289.7 | 372.3 | 282.2 | 251.9 |
| TD (g) | | | | |
| Tear Ratio | 8 | 11.1 | 9.5 | 8.1 |
| TD/MD | | | | |
| Std. Dev. MD | 2.62 | 3.74 | 1.88 | 1.98 |
| Std. Dev. TD | 34.72 | 38.08 | 114.08 | 37.52 |

TABLE 6
Puncture Data of Films with Different Core Compositions

| Film | 1 | 2 | 7 | 8 |
|---|---|---|---|---|
| Note | Baseline | Core with | Core with | Core with |
| | | nucleation | beta | beta |
| | | inhibitor | nucleator | nucleator and |
| | | | | nucleation |
| | | | | inhibitor |
| Maximum load | 5.31 | 5.39 | 5.67 | 5.25 |
| (lbf) | | | | |
| Maximum load | 0.13 | 0.17 | 0.25 | 0.32 |
| Std. Dev. | | | | |
| Total energy | 2.554 | 2.797 | 3.135 | 2.656 |
| (in-lbs) | | | | |
| Total energy | 0.38 | 0.11 | 0.19 | 0.14 |
| Std. Dev. | | | | |
| Force at break | 5.1 | 5.14 | 5.33 | 4.94 |
| (lbf) | | | | |
| Force at break | 0.07 | 0.25 | 0.24 | 0.31 |
| Std. Dev. | | | | |
| Elongation at | 0.76 | 0.8 | 0.84 | 0.78 |
| break (lbf) | | | | |
| Elongation at | 0.07 | 0.02 | 0.02 | 0.01 |
| break Std. Dev. | | | | |
| Gauge | 1.97 | 1.97 | 2.13 | 2.07 |
| Failure type | ⅔ no break, | ⅔ no break, | no break | no break |
| | ⅓ break | ⅓ break | | |

### D. Example 4—Effects of Nucleation Inhibitor in Different Layers

The effects of nucleation inhibitor in different film layers was then examined. The films examined in this set of tests include Film 1 (baseline, no nucleation inhibitor), Film 2 (core with nucleation inhibitor), Film 3 (skin with nucleation inhibitor), and Film 4 (core and skin with nucleation inhibitor).

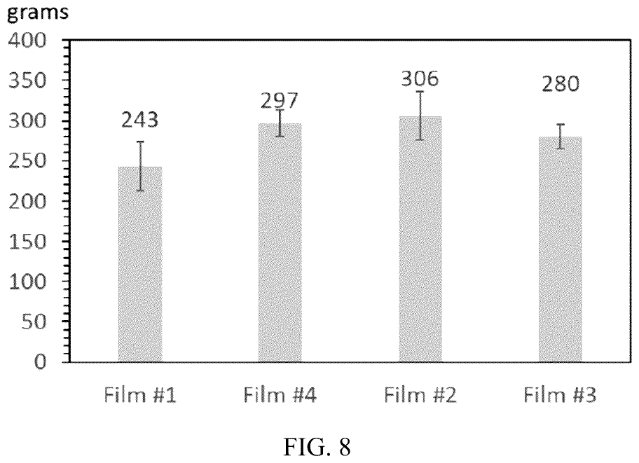

The use of a nucleation inhibitor consistently yielded higher falling dart impact strength performance (FIG. 8). Falling dart performance was improved by including the nucleation inhibitor in the skin (Film 3). The best performance was realized when the inhibitor was present in the core, followed closely by having the inhibitor in every film layer (Film 2 and Film 4, respectively). The latter performance can be attributed to the fact the skin layer represents only 30% of the overall structure (in terms of mass), combined with the quenching kinematics being faster in the skin layer and thereby lessening the inhibitor's beneficial performance.

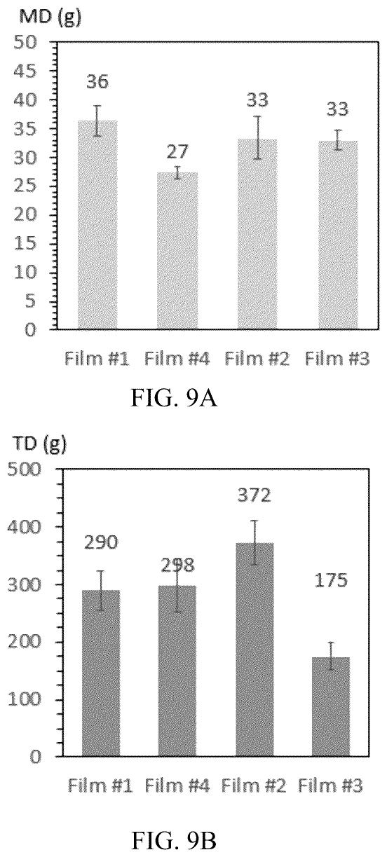

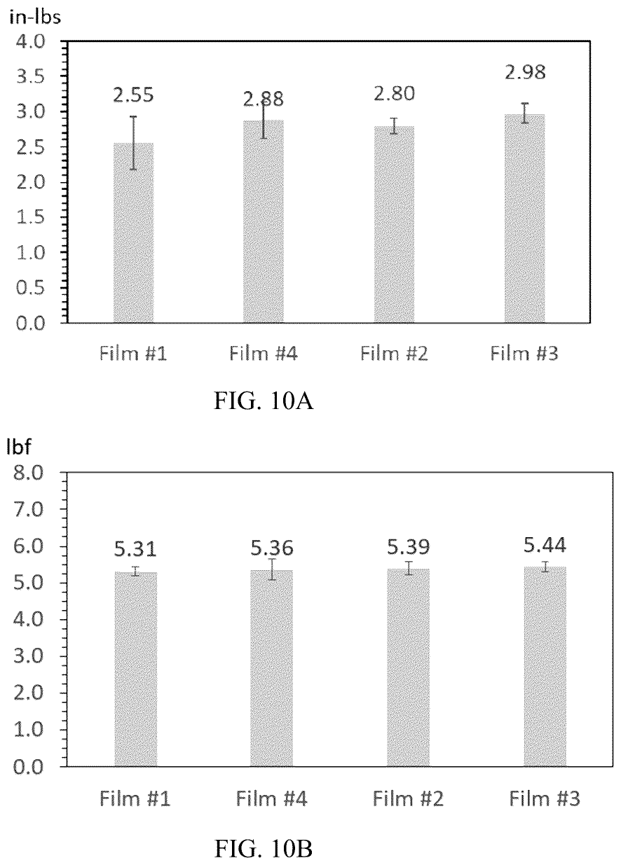

Films 1, 2, 3 and 4 were then evaluated for Elmendorf tear strength. Tear performance was influenced by nucleation inhibitor placement, with the film having a nucleation inhibitor present in only the core layer displaying the highest overall resistance to tearing (FIGS. 9A-9B). The results for Films 2, 3, and 4 suggest that including a nucleation inhibitor in skin layers is detrimental to TD tear strength (FIG. 9B). Puncture test results of films having nucleator inhibitor in different layers. Total puncture energy and maximum puncture load were similar for the four films (FIGS. 10A-10B). Overall, Film 2 (core with nucleation inhibitor) outperformed the other films in the strength tests, indicating that the inclusion of a nucleation inhibitor in the core layer of an A/B/A film had a positive effect on film strength. Table 7 below includes film falling dart and Elmendorf tear data. Table 8 below includes film puncture test data.

TABLE 7
Falling Dart and Tear Data of Films with Additive in Core vs Skin

| Film | 1 | 4 | 2 | 3 | 8 |
|---|---|---|---|---|---|
| Note | Baseline | 100% | Core with | Skin with | Core with |
| | | inhibitor | nucleation | nucleation | beta |
| | | | inhibitor | inhibitor | nucleator |
| | | | | | and |
| | | | | | nucleation |
| | | | | | inhibitor |
| Falling dart | 243 | 297 | 306 | 280 | 276 |
| (g) | | | | | |
| Falling dart | 30 | 17 | 30 | 15 | 49 |
| Std. Dev. | | | | | |
| Elmendorf | | | | | |
| Tear | | | | | |
| Pendulum | 200 | 200 | 200 | 200 | 200 |
| Weight MD | | | | | |
| Tear | 36.4 | 27.4 | 33.4 | 33.1 | 31 |
| Resistance | | | | | |
| MD (g) | | | | | |
| Pendulum | 800 | 800 | 800 | 800 | 800 |
| Weight TD | | | | | |
| Tear | 289.7 | 298.4 | 372.3 | 174.6 | 251.9 |
| Resistance | | | | | |
| TD (g) | | | | | |
| Tear Ratio | 8 | 10.9 | 11.1 | 5.3 | 8.1 |
| TD/MD | | | | | |
| Std. Dev. | 2.62 | 1.14 | 3.74 | 1.76 | 1.98 |
| MD | | | | | |
| Std. Dev. | 34.72 | 46.96 | 38.08 | 23.76 | 37.52 |
| TD | | | | | |

TABLE 8
Puncture Data of Films with Additive in Core vs Skin

| Film | 1 | 4 | 2 | 3 | 8 |
|---|---|---|---|---|---|
| Note | Baseline | 100% | Core with | Skin with | Core with beta |
| | | inhibitor | nucleation | nucleation | nucleator and |
| | | | inhibitor | inhibitor | nucleation |
| | | | | | inhibitor |
| Maximum load | 5.31 | 5.36 | 5.39 | 5.44 | 5.25 |
| (lbf) | | | | | |
| Maximum load | 0.13 | 0.28 | 0.17 | 0.14 | 0.32 |
| Std. Dev. | | | | | |
| Total energy | 2.554 | 2.881 | 2.797 | 2.978 | 2.656 |
| (in-lbs) | | | | | |
| Total energy | 0.38 | 0.26 | 0.11 | 0.14 | 0.14 |
| Std. Dev. | | | | | |
| Force at break | 5.1 | 5.05 | 5.14 | 5.11 | 4.94 |
| (lbf) | | | | | |
| Force at break | 0.07 | 0.24 | 0.25 | 0.13 | 0.31 |
| Std. Dev. | | | | | |
| Elongation at | 0.76 | 0.82 | 0.8 | 0.83 | 0.78 |
| break (lbf) | | | | | |
| Elongation at | 0.07 | 0.03 | 0.02 | 0.02 | 0.01 |
| break Std. Dev. | | | | | |
| Gauge | 1.97 | 2 | 1.97 | 2.03 | 2.07 |
| Failure type | ⅔ no break, | no break | ⅔ no break, | no break | no break |
| | ⅓ break | | ⅓ break | | |

### E. Example 5—Effects of Nucleation Modification in Core Versus Monolithically

The next set of tests examined the effects of including a nucleator modifier (beta nucleator and/or nucleation inhibitor) an all film layers versus including a nucleator modifier in only the core layer. The films were analyzed in three groups: Group 1) Film 2 (core with nucleation inhibitor) and Film 4 (core and skin with nucleation inhibitor); Group 2) Film 3 (skin with nucleation inhibitor), Film 5 (core and skin with beta nucleator), and Film 7 (core with beta nucleator); and Group 3) Film 6 (core and skin with both beta nucleator and nucleation inhibitor) and Film 8 (core with both beta nucleator and nucleation inhibitor). Film 1 includes neither a beta nucleator nor a nucleation inhibitor in any layers, and was used as the control film.

Group 1 evaluates placing the nucleation inhibitor in the core versus throughout the film. Group 2 evaluates placing the beta nucleator in the core versus throughout the film. Group 3 evaluates placing a combination of both beta nucleator and nucleation inhibitor throughout the film versus just in the core.

The purpose of these comparisons is to establish if certain compositions benefit from a tailored A/B/A film structure approach. For example, if equivalent performance is achieved in an A/B/A structure, where the A skin layers use an unnucleated polypropylene composition, that would be a lower cost option and therefore would likely have better commercial potential. Without being limited by theory, one could envision that the A layers would serve to insulate the core and allow more time for the nucleation modifiers to affect crystallization processes. This proposed insulating effect could garner unanticipated physical performance benefits in the final films.

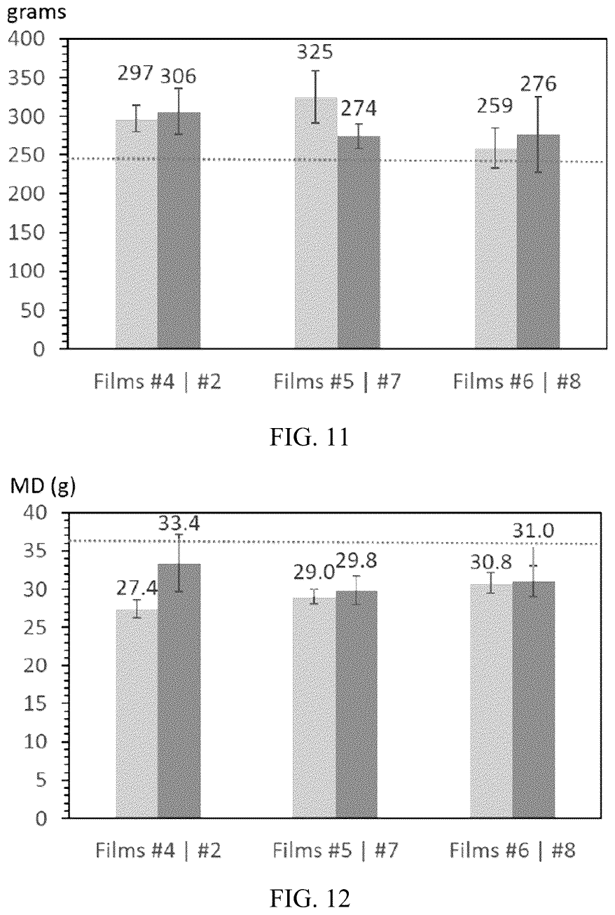

A comparison of dart impact strength analyses for the various films is depicted in FIG. 11. The nucleation inhibitor is effective either throughout the composition or when included in only the core layer (Film 4 and Film 2, respectively). Both films perform better than the baseline, unnucleated Film 1. Furthermore, the film with the nucleator inhibitor just in the core (Film 2) performs nominally better than the film with the nucleator inhibitor in both the skin and core layers (Film 4), albeit the results are within testing error ranges. This result suggests that performance benefit is achieved, primarily or exclusively, by including a nucleation inhibitor in the core layer. As such, it indicates a preferred embodiment of this technology involves a differentiated A/B/A film structure, with a nucleation inhibitor present in layer B. This arrangement can be beneficial in other potential film structures. In more complicated films (e.g., >3 layers), a nucleation-inhibited inner layer can be combined with distinct outer layers for other performance benefits (improved gloss, heat seal performance, printability and so forth) without sacrificing dart impact strength. This result presents a variety of opportunities for the film industry to optimize film structures for maximizing holistic performance.

The beta nucleator is effective either when included in only the core layer (Film 7), or when included throughout the composition (Film 5). Both films performed better in strength tests than baseline Film 1. The film with the beta nucleator in only the core (Film 7) has nominally lower impact strength than when the beta nucleator is in every film layer (Film 5), albeit the results are well within testing error ranges. This result suggests that the beta nucleator imparts strength when provided in the skin layers.

Combining both the beta nucleator and nucleation inhibitor provides a nominal benefit, but no synergistic effect, from a dart impact strength perspective. The film with this combination in the core layer (Film 8) exhibited incrementally higher dart impact strength as compared to the film with both the beta nucleator and nucleation inhibitor in all layers (Film 6).

MD tear strength results are depicted in FIG. 12. Machine direction tear strength was generally lower for films as compared to baseline Film 1. The nucleation inhibitor yielded a higher MD tear strength when restricted to the core layer (Film 2). This was a significant improvement over Film 4, where the nucleation inhibitor was included in all three layers. Film 2 also exhibited a tear strength that was within the testing error range of baseline Film 1.

The beta nucleator caused an appreciably lower tear strength, even when restricted to the core layer (Film 7). There was little benefit in limiting the beta nucleator to the core versus having it applied throughout the film (Film 5).

The blend of both the beta nucleator and nucleator inhibitor provided no synergies or outstanding benefits when provided in only the core layer (Film 8), as compared to including both beta nucleator and nucleator inhibitor in all three layers (Film 6).

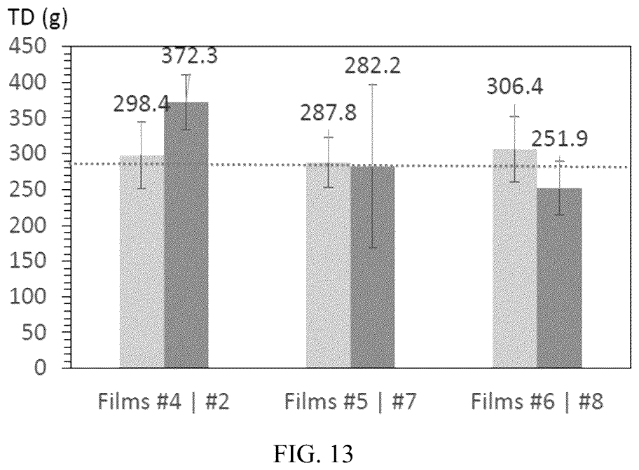

TD tear strength results are depicted in FIG. 13. The nucleation inhibitor yielded a higher TD tear strength when restricted to the core layer (Film 2). This result in combination with the higher MD data demonstrates that keeping the inhibitor in the core only makes for a more tear-resistant film. Keeping the inhibitor in the core also resulted in better TD tear strength than the unnucleated baseline (Film 1).

Films 5 and 7 exhibited equivalent TD tear strengths. These results indicate that inclusion of the beta nucleator provided tear strength similar, irrespective if the beta nucleator was confined to the core (Film 7) or used in all three layers (Film 5). Films 5 and 7 TD tear strengths were similar to that of unnucleated baseline Film 1.

Inclusion of both the beta nucleator and nucleator inhibitor provided no synergies or outstanding benefits when included in all three layers (Film 6) or when included in only the core layer (Film 8).

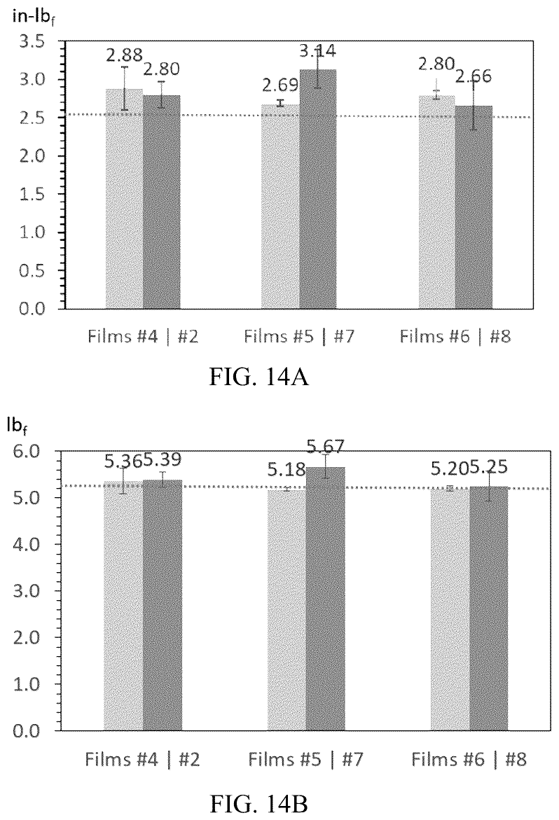

Slow puncture strength results (FIG. 14A) revealed additive-inclusive films were generally more puncture-resistant than additive-free baseline Film 1. Inclusion of the nucleation inhibitor yielded slightly improved results versus unnucleated Film 1, but slow puncture strength was essentially the same for Film 4 (core and skin with nucleation inhibitor) and Film 2 (core with nucleation inhibitor). Inclusion of the beta nucleator in all film layers (Film 5) also provided improved puncture-resistance over baseline Film 1. Inclusion of the beta nucleator provided the best slow puncture results when it was included in only the core layer (Film 7). The best maximum puncture load results were also observed when the nucleator was included in only the core layer (FIG. 14B). Slow puncture properties were slightly improved when both beta nucleator and nucleation inhibitor were included in all film layers (Film 6). Table 9 below includes film gauges and compares the falling dart data for all films. Table 10 blow includes Elmendorf tear data for all films. Table 11 below includes puncture data for all films.

TABLE 9
Falling Dart Data For All Films

| Film | 1 | 2 | 3 | 4 | 5 | 6 | 7 | 8 |
|---|---|---|---|---|---|---|---|---|
| Gauge (mils) | 1.97 | 1.97 | 2.03 | 2 | 2 | 1.97 | 2.13 | 2.07 |
| Falling Dart (g) | 243 | 306 | 280 | 297 | 325 | 259 | 274 | 276 |
| Falling Dart Std. Dev. | 30 | 30 | 15 | 17 | 34 | 26 | 16 | 49 |

TABLE 10
Tear Data For All Films

| Film | 1 | 2 | 3 | 4 | 5 | 6 | 7 | 8 |
|---|---|---|---|---|---|---|---|---|
| Pendulum Weight | 200 | 200 | 200 | 200 | 200 | 200 | 200 | 200 |
| MD | | | | | | | | |
| Tear Resistance | 36.4 | 33.4 | 33.1 | 27.4 | 29 | 30.8 | 29.8 | 31 |
| MD (g) | | | | | | | | |
| Pendulum Weight | 800 | 800 | 800 | 800 | 800 | 800 | 800 | 800 |
| TD | | | | | | | | |
| Tear Resistance | 289.7 | 372.3 | 174.6 | 298.4 | 287.8 | 306.4 | 282.2 | 251.9 |
| TD (g) | | | | | | | | |
| Tear Ratio | 8 | 11.1 | 5.3 | 10.9 | 9.9 | 9.9 | 9.5 | 8.1 |
| TD/MD | | | | | | | | |
| Std. Dev. MD | 2.62 | 3.74 | 1.76 | 1.14 | 1 | 1.38 | 1.88 | 1.98 |
| Std. Dev. TD | 34.72 | 38.08 | 23.76 | 46.96 | 35.68 | 46.48 | 114.08 | 37.52 |

TABLE 11
Puncture Data For All Films

| Film | 1 | 2 | 3 | 4 | 5 | 6 | 7 | 8 |
|---|---|---|---|---|---|---|---|---|
| Maximum load (lbf) | 5.31 | 5.39 | 5.44 | 5.36 | 5.18 | 5.2 | 5.67 | 5.25 |
| Maximum load Std. | 0.13 | 0.17 | 0.14 | 0.28 | 0.04 | 0.06 | 0.25 | 0.32 |
| Dev. | | | | | | | | |
| Total energy | 2.554 | 2.797 | 2.978 | 2.881 | 2.688 | 2.797 | 3.135 | 2.656 |
| (in-lbs) | | | | | | | | |
| Total energy Std. | 0.38 | 0.11 | 0.14 | 0.26 | 0.06 | 0.08 | 0.19 | 0.14 |
| Dev. | | | | | | | | |
| Force at break | 5.1 | 5.14 | 5.11 | 5.05 | 4.91 | 4.88 | 5.33 | 4.94 |
| (lbf) | | | | | | | | |
| Force at break | 0.07 | 0.25 | 0.13 | 0.24 | 0.04 | 0.05 | 0.24 | 0.31 |
| Std. Dev. | | | | | | | | |
| Elongation at | 0.76 | 0.8 | 0.83 | 0.82 | 0.8 | 0.82 | 0.84 | 0.78 |
| break (lbf) | | | | | | | | |
| Elongation at | 0.07 | 0.02 | 0.02 | 0.03 | 0.01 | 0.01 | 0.02 | 0.01 |
| break Std. Dev. | | | | | | | | |
| Failure type | ⅔ no | ⅔ no | no | no | no | no | no | no |
| | break, | break, | break | break | break | break | break | break |
| | ⅓ | ⅓ | | | | | | |
| | break | break | | | | | | |

As can be seen from the test results above, inclusion of a nucleation inhibitor in blown polypropylene films imparted higher dart impact strength, higher total energy and elongation at break in slow puncture testing, and more consistent puncture-resistance, with fewer breaks in slow-puncture testing. Inclusion of a beta nucleator in blown polypropylene films also imparted higher dart impact strength, higher total energy and elongation at break in slow puncture testing, and more consistent puncture-resistance, with fewer breaks in slow-puncture testing. Inclusion of a nucleation inhibitor in the core layer of blown polypropylene films provided higher dart impact strength and higher transverse direction tear strength. Inclusion of a beta nucleator in the core layer of blown polypropylene films provided higher dart impact strength, higher maximum load in slow puncture testing, higher total energy in slow puncture testing, and higher slow puncture testing elongation at break. Inclusion of a nucleation inhibitor in the skin layers of blown polypropylene films provided higher dart impact strength, higher maximum load in slow puncture testing, higher total energy in slow puncture testing, and higher elongation at break in slow puncture testing.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A blown polypropylene film or sheet comprising:
(a) at least 95 wt. % of a polypropylene; and
(b) at least one β-nucleating agent or crystallization inhibitor,
wherein the polypropylene blown film or sheet has a thickness of 0.5 mils to 15 mils, and
wherein the polypropylene blown film or sheet has an increased dart impact strength, as measure by ASTM D1709, when compared with a second polypropylene blown film that has the same components in the same wt. % amounts as the polypropylene blown film except that the second polypropylene blown film does not include the at least one β-nucleating agent or crystallization inhibitor.

2. The polypropylene blown film or sheet of claim 1, wherein the polypropylene is an impact copolymer.

3. The polypropylene blown film or sheet of claim 1, wherein the polypropylene is an impact copolymer propylene having all of:
a melt flow index of 0.1 to 5.0 g/10 min as measured by ASTM D1238 (230° C./2.16 kg);
a melting point of 150 to 175° C. as measured by ASTM D3418; and
a density of 0.7 to 1.1 g/cm³ as measured by ASTM D1505.

4. The polypropylene blown film or sheet of claim 1, wherein the film or sheet comprises the at least one β-nucleating agent.

5. The polypropylene blown film or sheet of claim 4, wherein the β-nucleating agent is N′,N′-dicyclohexil-2,6-naphthalene dicarboxamide.

6. The polypropylene blown film or sheet of claim 1, wherein the film or sheet comprises the at least one crystallization inhibitor.

7. The polypropylene blown film or sheet of claim 6, wherein the crystallization inhibitor is potassium stearate.

8. The polypropylene blown film or sheet of claim 1, wherein the film or sheet comprises 0.02 wt. % to 0.5 wt. % of the β-nucleating agent and/or 0.02 wt. % to 0.5 wt. % of the crystallization inhibitor.

9. The polypropylene blown film or sheet of claim 1, wherein the film or sheet is a multi-layered film.

10. The polypropylene blown film or sheet of claim 9, wherein the multi-layered film or sheet is an A/B/A co-extruded blown film or sheet, wherein A is a first film or sheet layer and a third film or sheet layer and B is a second film or sheet layer positioned in between the first and third film or sheet layers, and wherein the first and third film or sheet layers have the same composition.

11. The polypropylene blown film or sheet of claim 10, wherein each of the first, second, and third layers each comprise at least 95 wt. % of a polypropylene.

12. The polypropylene blown film or sheet of claim 11, wherein the first and third layers comprise the at least one β-nucleating agent and/or the at least one crystallization inhibitor.

13. The polypropylene blown film or sheet of claim 11, wherein the second layer comprises the at least one β-nucleating agent and/or the at least one crystallization inhibitor.

14. The polypropylene blown film or sheet of claim 11, wherein the second film or sheet layer comprises the at least one β-nucleating agent or crystallization inhibitor, and wherein the first and third film or sheet layers do not comprise either of the least one β-nucleating agent or the at least one crystallization inhibitor.

15. The polypropylene blown film or sheet of claim 11, wherein the A/B/A film has a 15/70/15% structure.

16. The polypropylene blown film or sheet of claim 1, comprising all of the following properties:
a dart impact strength of 75 g/mil to 250 g/mil, as measured by ASTM D1709;
a maximum load in slow puncture test of 2 lbf/mil to 4 lbf/mil, as measured by ASTM F1306;
a total energy in slow puncture test of 0.75 in-lbs/mil to 2 in-lb/mil, as measured by ASTM F1306;
an elongation at break in slow puncture test of 0.5 inches to 1.25 inches, as measured by ASTM F1306; and/or
a transverse direction tear strength of 50 g/mil to 250 g/mil, as measured by ASTM D1922.

17. The polypropylene blown film or sheet of claim 1, wherein the polypropylene is a homopolymer or a random copolymer or a blend thereof.

18. The polypropylene blown film or sheet of claim 1, wherein the β nucleating agent is N′, N′-dicyclohexil-2,6-naphthalene dicarboxamide, a gamma quinacridone, an aluminum salt of quinizarin sulphonic acid, a dihydroquinoacridin-dione, a quinacridin-tetrone, a triphenenol ditriazine, a combination of calcium carbonate and an organic acid, a combination of calcium stearate and pimelic acid, a calcium silicate, a dicarboxylic acid salt of metals of Group IIA, a delta-quinacridone, a diamide of adipic or suberic acid, a calcium salts of suberic or pimelic acid, an indigosol or cibantine organic pigment, an anthraquinone red pigment, or a bis-azo yellow pigment, or any combination thereof.

19. An article of manufacture comprising the polypropylene blown film or sheet of claim 1.

20. A process for producing a polypropylene blown film or sheet of claim 1, the process comprising:
obtaining an extrusion composition comprising at least one polypropylene resin and at least one of a crystallization inhibitor or a β nucleating agent;
extruding the extrusion composition through a first annular die to form a first molten tube;
blowing the first molten tube into a first tubular blown film or sheet; and
collapsing the first tubular blown film or sheet to form the polypropylene blown film or sheet.
